(19) United States
(12) Patent Application Publication
(10) Pub. No.: US 2022/0178168 A1
(43) Pub. Date: Jun. 9, 2022

(54) Hands-Free Door Opening System

(71) Applicant: Fernando Cuartas, West University Place, TX (US)

(72) Inventor: Fernando Cuartas, West University Place, TX (US)

(21) Appl. No.: 17/115,314

(22) Filed: Dec. 8, 2020

(51) Int. Cl. E05B 47/00; E05B 1/00

(52) U.S. Cl. CPC E05B 47/0001; E05B 1/0015; E05B 2047/0073; E05B 2047/0067; E05Y 2900/132; E05Y 2400/45; E05Y 2400/612; E05Y 2400/66; E05Y 2400/44

(57) ABSTRACT

A hands-free door opening system for opening doors without contact includes a foot pull apparatus and a hands-free door hardware apparatus. The foot pull apparatus comprises a pull plate coupled to a door. A pull body coupled to the pull plate and the pull plate define a pull cavity dimensioned to receive a user's foot. The hands-free door hardware apparatus comprises a sensor housing coupled to a wall adjacent the door. A fob sensor is coupled within the sensor housing to recognize the presence of an authorized key fob. A transmitter is coupled within the sensor housing and is in operational communication with the fob sensor. An electronic door handle is coupled within the door and has a receiver in communication with the transmitter to disengage when the authorized key fob is detected.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to door hardware devices and more particularly pertains to a new door hardware device for opening doors without contact.

### (2) Description of Related Art Including Information Disclosed Under 37 CFR 1.97 and 1.98

The prior art relates to door hardware devices. Existing devices allow doors to be opened without use of the hands. These devices focus on different ways of unlocking door mechanisms without using the hands, but generally do not provide a way of physically opening the door without using the hands. Few devices allow for the foot to be used to pull open a door.

### BRIEF SUMMARY OF THE INVENTION

An embodiment of the disclosure meets the needs presented above by generally comprising a foot pull apparatus and a hands-free door hardware apparatus. The foot pull apparatus comprises a pull plate configured to be coupled to a door. A pull body is coupled to the pull plate. The pull body has an arcuate profile and an open body bottom side. The pull body and the pull plate define a pull cavity dimensioned to receive a user's foot. The hands-free door hardware apparatus comprises a sensor housing configured to be coupled to a wall adjacent the door. A fob sensor is coupled within the sensor housing. The fob sensor recognizes the presence of an authorized key fob. A transmitter is coupled within the sensor housing. The transmitter is in operational communication with the fob sensor. A sensor battery is coupled within the sensor housing. The sensor battery is in operational communication with the transmitter. An electronic door handle is configured to be coupled within the door. A receiver is coupled within the electronic door handle and is in operational communication with the transmitter. A handle battery is coupled within the electronic door handle and is in operational communication with the receiver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a hands-free door opening system according to an embodiment of the disclosure.

FIG. 2 is a front elevation view of an embodiment of the disclosure.

FIG. 3 is a side elevation view of an embodiment of the disclosure.

FIG. 4 is cross-sectional view of an embodiment of the disclosure along the line 4-4 of FIG. 2.

FIG. 5 is a front elevation view of an embodiment of the disclosure.

FIG. 6 is a rear elevation view of an embodiment of the disclosure.

FIG. 7 is a side elevation view of an embodiment of the disclosure.

### DETAILED DESCRIPTION OF THE INVENTION

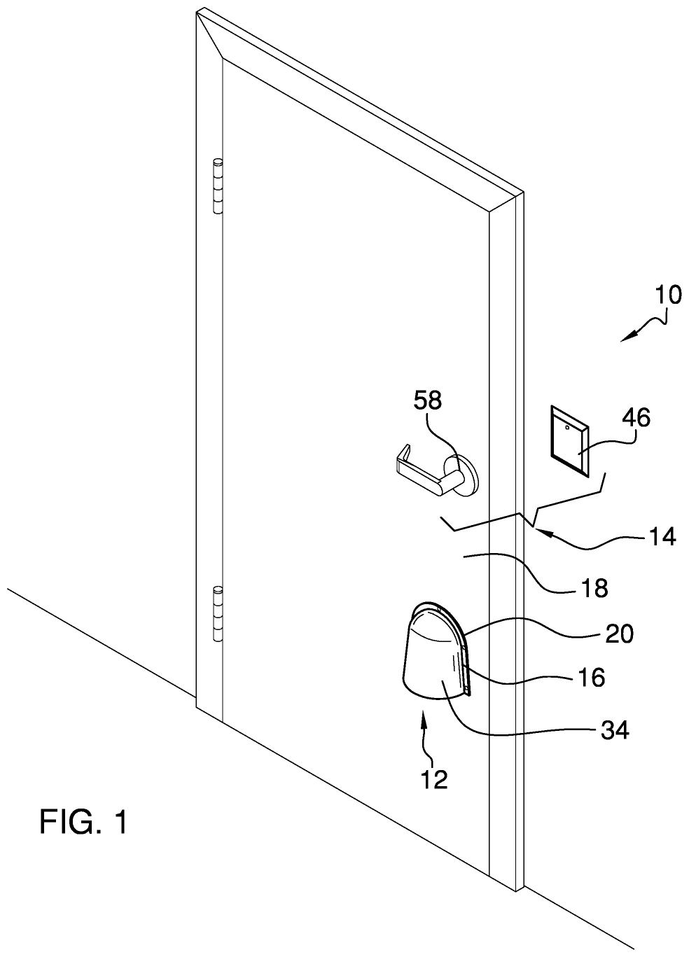

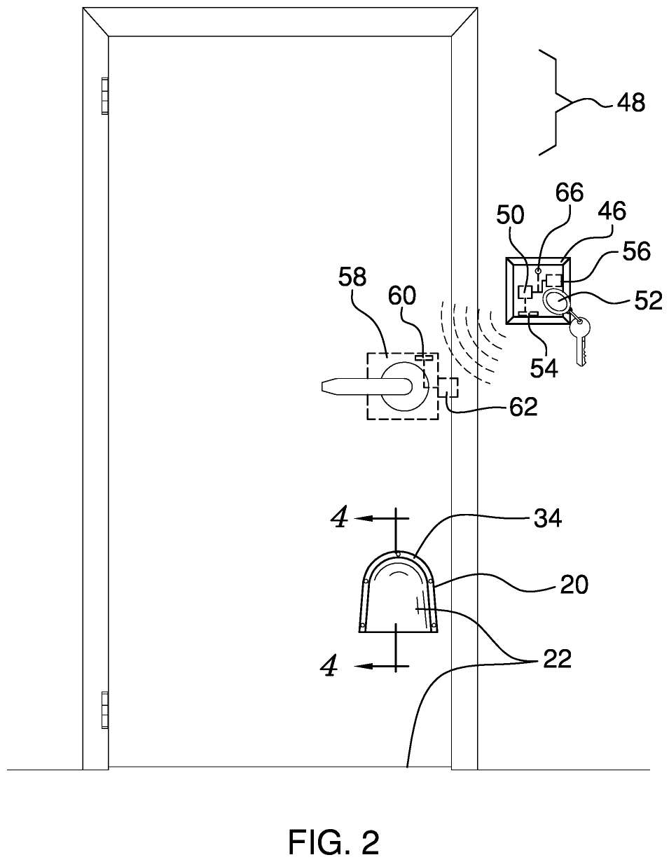

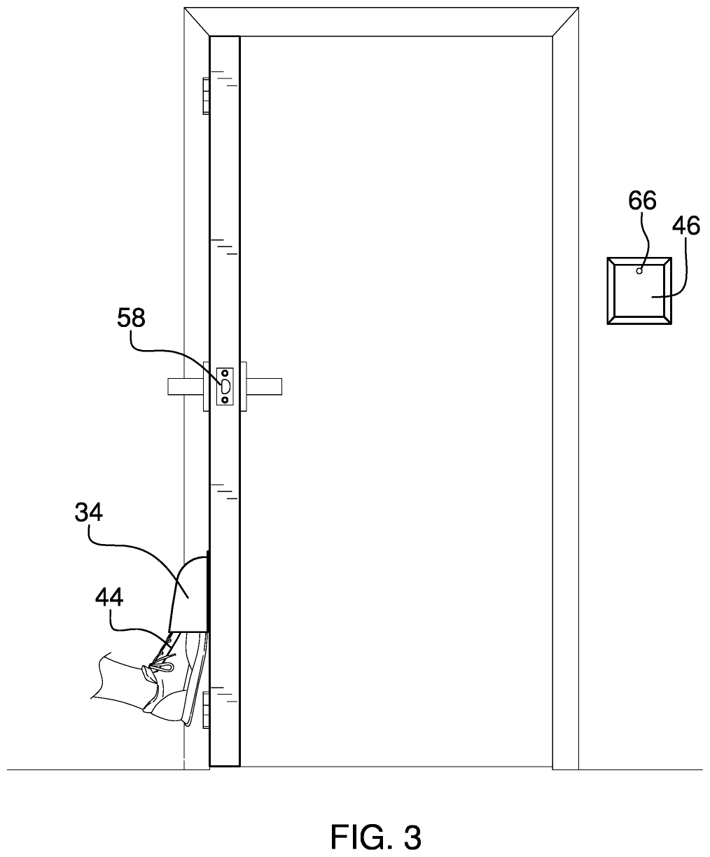

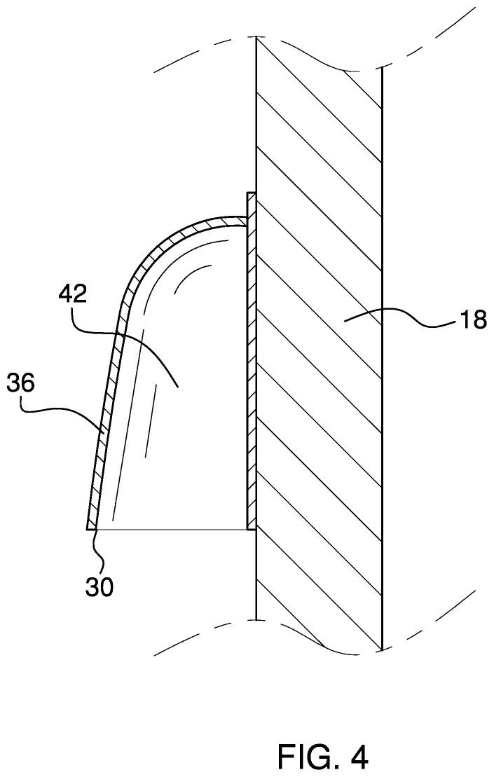

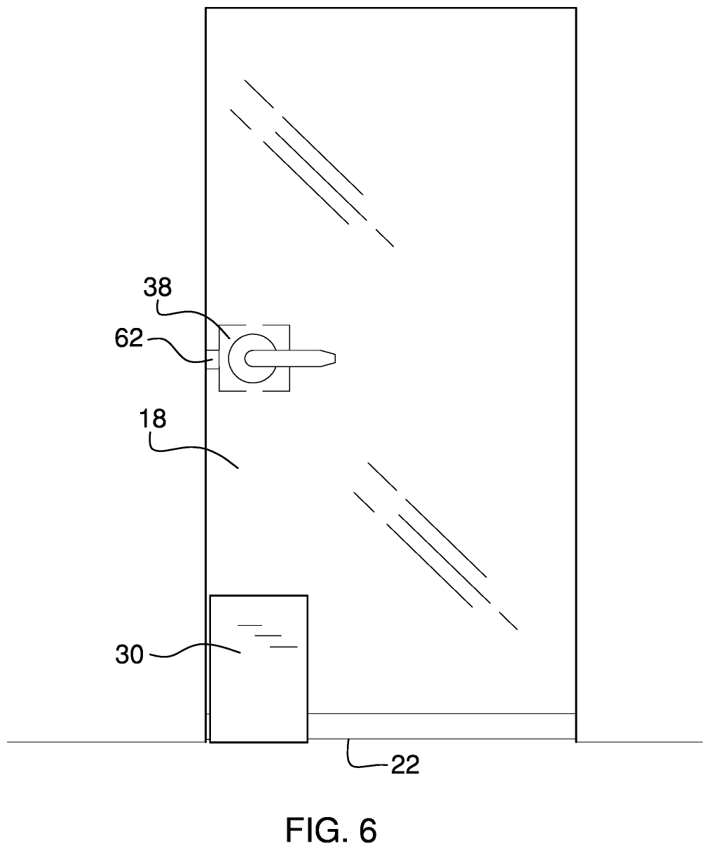

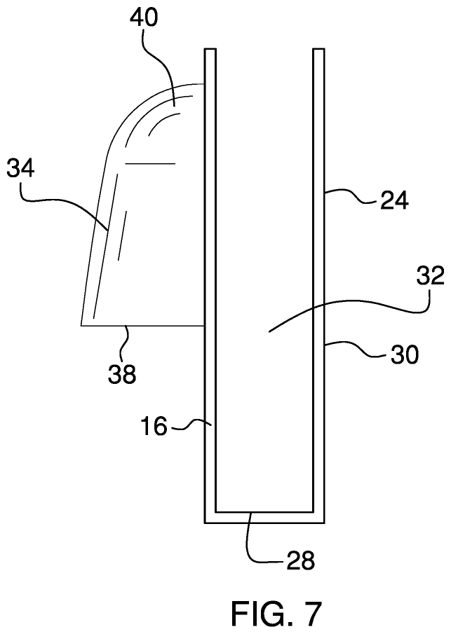

With reference now to the drawings, and in particular to FIGS. 1 through 7 thereof, a new door hardware device embodying the principles and concepts of an embodiment of the disclosure and generally designated by the reference numeral 10 will be described.

As best illustrated in FIGS. 1 through 7, the hands-free door opening system 10 generally comprises a foot pull apparatus 12 and a hands-free door hardware apparatus 14. The foot pull apparatus comprises a pull plate 16 configured to be coupled to a door 18. The pull plate 16 may have an inverted U-shaped outer edge 20. The pull plate 16 may receive a plurality of mounting hardware 21 adjacent the outer edge 20 or may alternatively be adhered to the door 18.

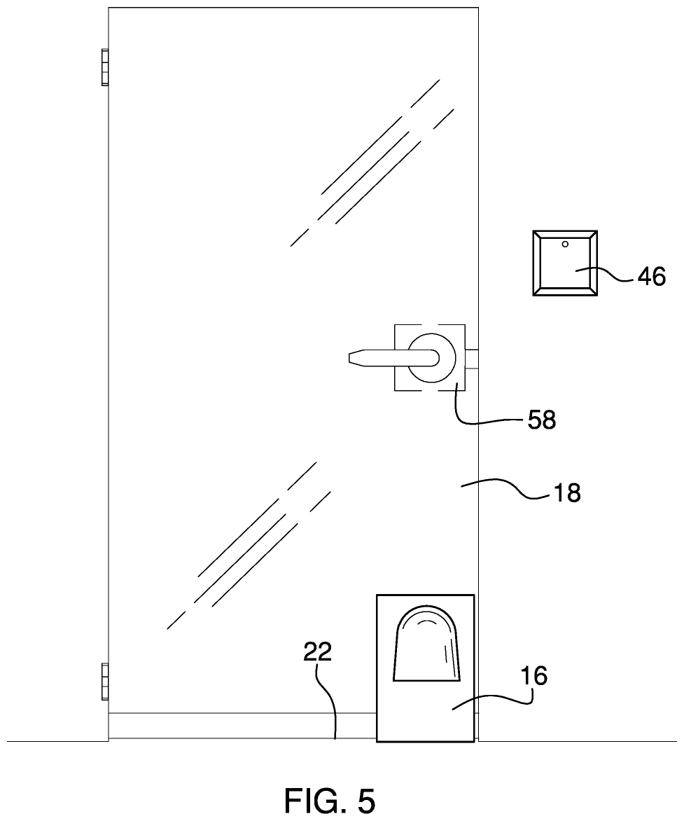

In an alternative embodiment of the invention shown in FIGS. 5-7, the pull plate 16 is rectangular and extends to a bottom edge 22 of the door. A push plate 24 is coupled to the pull plate 16. The push plate 24 has a connector portion 28 extending horizontally from the pull plate 16 underneath the door 18 and a push portion 30 lying in a plane parallel to the pull plate 16. The push portion 30 and the pull plate 16 define a door channel 32 conforming to the thickness of the door 18.

A pull body 34 is coupled to the pull plate 16. The pull body 34 may have an arcuate profile 36 and an open body bottom side 38. The pull body 34 may taper thinner towards a quarter-spherical body top side 40. The pull body 34 and the pull plate 16 defining a pull cavity 42 dimensioned to receive a user's foot 44.

The hands-free door hardware apparatus 14 comprises a sensor housing 46 configured to be coupled to a wall 48 adjacent the door 18. The sensor housing 46 may be rectangular prismatic with beveled edges. A fob sensor 50 is coupled within the sensor housing 46 to recognize the presence of an authorized key fob 52. A transmitter 54 is coupled within the sensor housing 46 and is in operational communication with the fob sensor 50. A sensor battery 56 is coupled within the sensor housing 46. The sensor battery 56 is in operational communication with the transmitter 54.

An electronic door handle 58 is configured to be coupled within the door 18. A receiver 60 is coupled within the electronic door handle 58 and is in operational communication with the transmitter 54. The electronic door handle 58 selectively engages and disengages a throw 62 to prevent or allow the door 18 from opening. A handle battery 64 is coupled within the electronic door handle 58 and is in operational communication with the receiver 60. A status light 66 may be coupled to the sensor housing 46 and is in operational communication with the fob sensor 50.

In use, the user presents the key fob 52 to the sensor housing 46 to be detected by the fob sensor 50. The electronic door handle 58 then frees the door 18 to be opened. The user may then place his or her foot in the pull cavity 42 to open the door with no hands for convenience and to prevent the spread of viruses, bacteria, and germs.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hands-free door opening system comprising:
a foot pull apparatus comprising:
a pull plate, the pull plate being configured to be coupled to a door; and
a pull body coupled to the pull plate, the pull body having an arcuate profile and an open body bottom side, the pull body and the pull plate defining a pull cavity dimensioned to receive a user's foot; and
a hands-free door hardware apparatus comprising:
a sensor housing, the sensor housing being configured to be coupled to a wall adjacent the door;
a fob sensor coupled within the sensor housing, the fob sensor recognizing the presence of an authorized key fob;
a transmitter coupled within the sensor housing, the transmitter being in operational communication with the fob sensor;
a sensor battery coupled within the sensor housing, the sensor battery being in operational communication with the transmitter;
an electronic door handle, the electronic door handle being configured to be coupled within the door;
a receiver coupled within the electronic door handle, the receiver being in operational communication with the transmitter; and
a handle battery coupled within the electronic door handle, the handle battery being in operational communication with the receiver.

2. The hands-free door opening system of claim 1 further comprising the pull plate having an inverted U-shaped outer edge.

3. The hands-free door opening system of claim 1 further comprising the pull body covering all of the pull plate excepting an outer lip.

4. The hands-free door opening system of claim 3 further comprising the outer lip receiving a plurality of mounting hardware configured to secure the apparatus to the door.

5. The hands-free door opening system of claim 1 further comprising a plate bottom side of the pull plate and the body bottom side lying coplanar in a horizontal plane.

6. The hands-free door opening system of claim 1 further comprising the pull plate being rectangular and extending to a bottom edge of the door; a push plate being coupled to the pull plate, the push plate having a connector portion extending horizontally from the pull plate underneath the door and a push portion lying in a plane parallel to the pull plate, the push portion and the pull plate defining a door channel conforming to the thickness of the door.

7. The hands-free door opening system of claim 1 further comprising the sensor housing being rectangular prismatic and having beveled edges.

8. The hands-free door opening system of claim 1 further comprising a status light coupled to the sensor housing, the status light being in operational communication with the fob sensor.

9. A hands-free door opening system comprising:
a foot pull apparatus comprising:
a pull plate, the pull plate having an inverted U-shaped outer edge, the pull plate being configured to be coupled to a door; and
a pull body coupled to the pull plate, the pull body having an arcuate profile and an open body bottom side, the pull body and the pull plate defining a pull cavity dimensioned to receive a user's foot; and
a hands-free door hardware apparatus comprising:
a sensor housing, the sensor housing being configured to be coupled to a wall adjacent the door, the sensor housing being rectangular prismatic and having beveled edges;
a fob sensor coupled within the sensor housing, the fob sensor recognizing the presence of an authorized key fob;
a transmitter coupled within the sensor housing, the transmitter being in operational communication with the fob sensor;
a sensor battery coupled within the sensor housing, the sensor battery being in operational communication with the transmitter;
an electronic door handle, the electronic door handle being configured to be coupled within the door;
a receiver coupled within the electronic door handle, the receiver being in operational communication with the transmitter;
a handle battery coupled within the electronic door handle, the handle battery being in operational communication with the receiver; and
a status light coupled to the sensor housing, the status light being in operational communication with the fob sensor.
